(19) United States
(12) Patent Application Publication
(10) Pub. No.: US 2022/0206406 A1
(43) Pub. Date: Jun. 30, 2022

(54) TONER FOR DEVELOPING ELECTROSTATIC IMAGE

(71) Applicant: Hewlett-Packard Development Company, L.P., Spring, TX (US)

(72) Inventors: Seyoung Yoon, Suwon-sikr (KR); Kyeonghwan CHOI, Suwon-si (KR); Woochul JUNG, Suwon-si (KR)

(73) Assignee: Hewlett-Packard Development Company, L.P., Spring, TX (US)

(21) Appl. No.: 17/598,476

(22) PCT Filed: Sep. 8, 2020
(86) PCT No.: PCT/US2020/049647

§ 371 Date: Sep. 27, 2021

(30) Foreign Application Priority Data
Nov. 29, 2019 (KR) 10-2019-0156951

(51) Int. Cl. G03G 9/097; G03G 9/093; G03G 9/08; G03G 15/08

(52) U.S. Cl. CPC G03G 9/09716; G03G 9/09364; G03G 15/0865; G03G 9/0819; G03G 9/09725

(57) ABSTRACT

An example toner having a plurality of toner particles is provided. The toner particles include a core particle including a binder resin, a colorant, and a releasing agent, and an external additive to attach to a surface of the core particle, the external additive including silica particles and tin oxide particles.

### BACKGROUND

For various printing methods such as full-color printing, high-speed printing, and high-quality image printing, issues such as compact size (lightweight), low printing costs, and environment-friendly printing have focused attention on techniques for adjusting the shapes and surfaces of toner particles as they are becoming increasingly important to satisfy physical properties of toners for electrophotographic processes performed in printers.

With an increased printing speed of a printer, a shearing force is exerted on a toner an increased number of times. Therefore, a durability of the toner should be considered. Also, to realize compact and environment-friendly printers, an amount of “untransferred toner” should be reduced. To this end, charge uniformity and transferability of the toner may be considered.

### DETAILED DESCRIPTION OF EXAMPLES

Hereinafter, a toner for developing an electrostatic image according to an example will be described.

An example toner for developing an electrostatic image includes a plurality of toner particles. Each of the toner particles includes a core particle and an external additive attached to a surface of the core particle. The core particle includes a binder resin, a colorant, and a releasing agent. The external additive attached to the surface of the core particle includes silica particles and tin oxide particles.

An example toner for developing an electrostatic image, in which X-ray diffraction intensity 2θ, determined in units of counts per second (cps) of the toner measured by an X-ray diffractometer (XRD), may satisfy the following conditions (1) to (3):

0.4<[intensity of 2θ=26.6±0.2°,2θ=33.8±0.2°,2θ=51.8±0.2°]<500; (1)

0≤[intensity of 2θ=25.3±0.2°,2θ=48.0±0.2°]<10; and (2)

0≤[intensity of 2θ=27.4±0.2°,2θ=36.1,2θ=54.3±0.2°]<10. (3)

The XRD may be a Rigaku ULTIMA IV XRD.

Examples of the binder resin may include, but are not limited to, a styrenic resin, an acrylic resin, a vinyl resin or polyolefin resin, a polyether-based polyol resin, a phenolic resin, a silicone resin, a polyester resin, an epoxy resin, a polyamide resin, a polyurethane resin, a polybutadiene resin, or any mixture thereof.

Examples of the styrenic resin may include, but are not limited to, polystyrene, a homopolymer of a styrenic monomer such as poly-p-chlorostyrene or polyvinyltoluene, a styrene-based copolymer such as a styrene-p-chlorostyrene copolymer, a styrene-vinyltoluene copolymer, a styrene-vinyl naphthalene copolymer, a styrene-acrylic acid ester copolymer, a styrene-methacrylic acid ester copolymer, a styrene-methyl α-chloromethacrylate copolymer, a styrene-acrylonitrile copolymer, a styrene-vinyl methyl ether copolymer, a styrene-vinyl ethyl ether copolymer, a styrene-vinyl methyl ketone copolymer, a styrene-butadiene copolymer, a styrene-isoprene copolymer, a styrene-acrylonitrile-indene copolymer, or any mixture thereof.

Examples of the acrylic resin may include, but are not limited to, a polymer of acrylic acid, a polymer of methacrylic acid, a polymer of methyl methacrylate, a polymer of methyl α-chloromethacrylate, or any mixture thereof.

Examples of the vinyl resin or polyolefin resin may include, but are not limited to, polyvinyl chloride, polyethylene, polypropylene, polyacrylonitrile, polyvinyl acetate, or any mixture thereof.

The polyester resin may be prepared via reaction between an aliphatic, alicyclic, or aromatic polybasic carboxylic acid or alkyl ester thereof and a polyhydric alcohol via direct esterification or trans-esterification.

Examples of the polybasic carboxylic acid may include phthalic acid, isophthalic acid, terephthalic acid, tetrachlorophthalic acid, chlorophthalic acid, nitrophthalic acid, p-carboxyphenylacetic acid, p-phenylene-2-acetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and/or cyclohexane dicarboxylic acid. Also, in addition to the dicarboxylic acid, a polybasic carboxylic acid such as trimellitic acid, pyromellitic acid, naphthalene tricarboxylic acid, naphthalene tetracarboxylic acid, pyrene tricarboxylic acid, and pyrene tetracarboxylic acid may be used. In addition, derivatives of a carboxylic acid in which the carboxylic group thereof is reacted to form an anhydride, oxychloride, or ester group may be used. Among them, terephthalic acid or lower esters thereof, diphenyl acetic acid, cyclohexane dicarboxylic acid, or the like may be used. The lower ester refers to an ester of aliphatic alcohol having one to eight carbon atoms.

Examples of the polyhydric alcohol may include an aliphatic diol such as ethylene glycol, diethylene glycol, triethylene glycol, propylene glycol, butane diol, hexane diol, neopentyl glycol, or glycerine, an alicyclic diol such as cyclohexane diol, cyclohexane dimethanol, or hydrogen-added bisphenol A, and an aromatic diol such as ethylene oxide adduct of bisphenol A or propylene oxide adduct of bisphenol A. One or more polyhydric alcohol may be used. Among these polyhydric alcohols, an aromatic diol and an alicyclic diol may be used. For example, an aromatic diol may be used. In addition, a polyhydric alcohol having three or more —OH groups, such as glycerin, trimethylol propane, or pentaerythritol may be used together with the diol to have a cross-linked structure or a branched structure to increase fixability or fusibility of the toner.

An example number average molecular weight of the binder resin may be in the range of about 700 to about 1,000,000 g/mol, or about 10,000 to about 500,000 g/mol. An example binder resin may include a combination of a high molecular weight binder resin and a low molecular weight binder resin in an appropriate ratio. An example number average molecular weight of the high molecular weight binder resin may be, for example, from about 100,000 to about 500,000 g/mol, and an example number average molecular weight of the low molecular weight binder resin may be, for example, from about 1000 to about 100,000 g/mol. The two types of binder resins having different molecular weights may have independent functions. As an example, the low molecular weight binder resin has little molecular chain entanglements, thereby contributing to fusibility and gloss. On the contrary, the high molecular weight binder resin may maintain a certain level of elasticity even at a high temperature due to many molecular chain entanglements, thereby contributing to anti-hot offset properties.

The colorant may be, for example, a black colorant, a yellow colorant, a magenta colorant, a cyan colorant, or any combination thereof.

For example, the black colorant may be carbon black, aniline black, or any mixture thereof.

For example, the yellow colorant may be a condensed nitrogen compound, an isoindolinon compound, an anthraquinone compound, an azo metal complex, an allyl imide compound, or any mixture thereof. As an example, the yellow colorant may be, but is not limited to, “C.I. Pigment Yellow” 12, 13, 14, 17, 62, 74, 83, 93, 94, 95, 109, 110, 111, 128, 129, 147, 168, or 180.

For example, the magenta colorant may be a condensed nitrogen compound, an anthraquinone compound, a quinacridone compound, a base dye lake, a naphthol compound, a benzoimidazole compound, a thioindigo compound, a perylene compound, or any mixture thereof. As an example, the magenta colorant may be, but is not limited to, “C.I. Pigment Red” 2, 3, 5, 6, 7, 23, 48:2, 48:3, 48:4, 57:1, 81:1, 122, 144, 146, 166, 169, 177, 184, 185, 202, 206, 220, 221, or 254.

For example, the cyan colorant may be a copper phthalocyanine compound or a derivative thereof, an anthraquinone compound, a base dye lake, or any mixture thereof. As an example, the cyan colorant may be, but is not limited to, “C.I. Pigment Blue” 1, 7, 15, 15:1, 15:2, 15:3, 15:4, 60, 62, or 66.

The amount of the colorant included in the core particle may be, for example, from about 0.1 parts by weight to about 20 parts by weight, for example, from about 2 parts by weight to about 10 parts by weight, based on 100 parts by weight of the binder resin, without being limited thereto.

Examples of the releasing agent may include, but are not limited to, a polyethylene-based wax, a polypropylene-based wax, a silicone-based wax, a paraffin-based wax, an ester-based wax, a carnauba-based wax, a metallocene-based wax, or any mixture thereof.

The releasing agent may have, for example, a melting point of from about 50° C. to about 150° C., without being limited thereto. The amount of the releasing agent included in the core particle may be, for example, from about 1 part by weight to about 20 parts by weight, or from about 1 part by weight to about 10 parts by weight, based on 100 parts by weight of the binder resin. The releasing agent may prevent the toner particles from sticking to a heating roller of a fixing device.

The core particles may be prepared by, for example, a pulverization process, an aggregation process, or a spraying process. The pulverization process may be performed by, for example, pulverizing after melting and mixing a binder resin, a colorant, and a releasing agent. The aggregation process may be performed by, for example, mixing a binder resin dispersion, a colorant dispersion, and a releasing agent dispersion, aggregating these particles of the binder resin, the colorant, and the releasing agent, and combining the resulting aggregates.

A volume average particle diameter of the core particles may be, but is not limited to, from about 4 μm to about 20 μm, or from about 5 μm to about 10 μm.

A shape of the core particles is also not particularly limited. As the shape of the core particles is closer to a sphere, a charging stability of the toner and a dot reproducibility of a print image may be enhanced. For example, the core particles may have sphericity in a range of, for example, about 0.90 to about 0.99.

External additives may be attached to the surfaces of the core particles.

Surface characteristics of toner particles may affect charging uniformity, charging stability, transferability, and cleaning ability of the toner particles. One factor affecting the surface characteristics of the toner particles is an external additive added to a surface of the toner particles. One function of the external additive is to maintain fluidity of the toner particles by preventing the toner particles from sticking together. The external additive may also affect charging uniformity, charging stability, transferability, and cleaning ability.

A behavior of external additives may cause of a change in a charge amount of the toner. For example, if a combination of silica particles and tin oxide particles is used as external additives of the toner, and the X-ray diffraction intensity 28 in terms of cps of the toner measured by an XRD is adjusted to satisfy the following conditions (1) to (3) below, developing properties, transferring properties, photoreceptor background contamination inhibiting properties, and developing durability are improved:

0.4<[intensity of 2θ=26.6±0.2°,2θ=33.8±0.2°,2θ=51.8±0.2°]<500; (1)

0≤[intensity of 2θ=25.3±0.2°,2θ=48.0±0.2°]<10; and (2)

0≤[intensity of 2θ=27.4±0.2°,2θ=36.1,2θ=54.3±0.2°]<10 (3)

That is, a surface characteristic of the toner for developing an electrostatic image according to an example may be modified by using a combination of silica particles and tin oxide particles as external additives to satisfy condition (1) above, and if desired, all of conditions (1) to (3). In the case of using a combination of silica particles and tin oxide particles as external additives so as to satisfy the above conditions (1) to (3), characteristics such as environmental charging stability, developing properties, transferring properties, photoreceptor background contamination inhibiting properties, and developing durability may be improved.

Further, a combination of silica particles and tin oxide particles may be used as external additives such that the X-ray fluorescence intensity of tin oxide [Sn] as determined in units of kilocounts per second (kcps) of the toner, and the X-ray fluorescence intensity of silicon [Si] as determined in units of kcps of the toner, measured by X-ray fluorescence (XRF) spectrometry, satisfy the condition (4) below:

0.00<[Sn]/[Si]≤1000. (4)

By using the combination of the external additives, the toner for developing an electrostatic image according to an example may have the following effects.

First, the toner may have improved environmental charging stability due to a low difference in charge amount between high-temperature and high-humidity conditions and low-temperature and low-humidity conditions when compared with a toner including only silica particles as an external additive. The toner may also provide improved developing properties, transferring properties, photoreceptor background contamination inhibiting properties, and developing durability when compared with a toner including only silica particles. The toner may also have improved image characteristics over time such as an improved image density retention property and a charge retention property even after long-term storage.

In contrast, if the above conditions are not satisfied, one or more characteristic of the toner, for example, environmental charging stability, developing properties, transferring properties, photoreceptor background contamination inhibiting properties, and developing durability, may not exhibit the desired effects.

For example, when the above conditions are not satisfied, any one of the following results may appear.

In terms of environmental charging stability, the ratio of the charge amount maintained under a high temperature and high humidity condition to the charge amount maintained under a low temperature and low humidity condition may be less than 0.7, such that the difference in the environmental charge amount ratio may be very large. In terms of developing properties, the developing efficiency (e.g., weight of toner per unit area of electrophotographic photoreceptor/weight of toner per unit area of developing roller X 100 (%)) may be less than 70%. In terms of transferability, the transferability calculated as follows may be less than 70%:

Primary transferability=Weight of toner per unit area of intermediate transfer member/weight of toner per unit area of electrophotographic photoreceptor×100(%).

Secondary transferability=Weight of toner per unit area of paper/weight of toner per unit area of intermediate transfer member×100(%).

Transferability=Primary transferability×Secondary transferability.

In terms of photoreceptor background contamination, when, after printing images on 1000 sheets of paper, a non-image area on a photoreceptor drum is taped and optical densities are measured at three locations, a calculated average thereof may be 0.07 or greater. This indicates that photoreceptor background contamination prevention performance of the toner is poor. In terms of developing durability, when images are printed on up to 5000 sheets of paper and image densities over time are measured at every print of 1000 sheets to evaluate degrees of changes in comparison with an initial state as the number of prints increases, the measurement result is 40% or more of a change in image density after printing 5000 sheets when compared to the initial state. This indicates a poor developing durability of the toner.

Thus, an example toner may stably provide images with improved image quality without using additives such as titanium oxide (TiO₂) due to improved dot reproducibility regardless of environmental changes and the lapse of time.

When the tin oxide particles and silica particles are used as external additives such that the X-ray diffraction intensity 28 determined in units of cps of the toner measured by an XRD satisfies all the conditions (1) to (3) above, the particles improve to maintain charging stability, developing properties, transferring properties, photoreceptor background contamination inhibiting properties, and developing durability at predetermined levels or higher for a long period of time. Thus, by using an example toner, effects of appropriate and uniform concentration of toner, reduced background contamination, reduced contamination due to scattered toner, and appropriate consumption of toner may be obtained.

As described above, the external additives including silica particles and tin oxide particles are attached to the surface of the core particles according to an example.

The silica particles may be, for example, fumed silica, sol-gel silica, or a mixture thereof. When the primary particle size of the silica particles is too large, toner particles externally added therewith may be relatively difficult to pass through a developing blade. Accordingly, a selection phenomenon of toner may occur.

That is, as a toner cartridge continues to be used, a particle size of the toner particles remaining in the toner cartridge gradually increases. As a result, the quantity of charge of the toner decreases and thus the thickness of a toner layer developing an electrostatic image increases. In addition, when the primary particle size of the silica particles is too large, a probability of the silica particles separating from the core particles may increase due to a stress applied to the toner particles from a member such as a feed roller. The separated silica particles may contaminate a charging member or a latent image carrier.

On the other hand, when the primary particle size of the silica particles is too small, the silica particles are likely to be embedded into the core particles due to a shearing stress of a developing blade that is applied to the toner particles. If the silica particles are embedded into the core particles, the silica particles lose their functionality as an external additive. Accordingly, adhesion between the toner particles and the surface of a photoconductor may be undesirably increased. This may lead to a reduction in a cleaning ability and a transferability of the toner. For example, the silica particles may be small-diameter silica particles, such as small-diameter fumed silica particles having a volume average particle diameter D50 of about 5 nm to less than about 50 nm, or about 5 nm to less than about 40 nm, about 5 nm to less than about 30 nm, or about 5 nm to less than about 20 nm. In this regard, the average particle diameter D50 refers to a diameter at which the cumulative volume of the silica particles corresponds to 50% of the total cumulative volume of the silica particles in a cumulative volume curve of the silica particles.

According to an example, large-diameter silica particles may further be used to compensate drawbacks caused when using only the small-diameter silica particles. The large-diameter silica particles may be, for example, large-diameter sol-gel silica particles, such as monodispersed large-diameter sol-gel silica particles having a volume average particle diameter D50 of about 50 nm to about 300 nm, about 50 nm to about 150 nm, about 50 nm to about 120 nm, about 50 nm to about 100 nm, or about 60 nm to about 80 nm. According to an example, the silica particles may include a combination of large-diameter silica particles and small-diameter silica particles.

An amount of large-diameter silica particles may be from about 0.1 parts by weight to about 3 parts by weight, for example, from about 0.5 parts by weight to about 2.5 parts by weight, from about 1 part by weight to about 2.5 parts by weight, or from about 1 part by weight to about 2 parts by weight based on 100 parts by weight of the toner particles. An amount of small-diameter silica particles may be from about 0.1 parts by weight to about 2 parts by weight, for example, from about 0.5 parts by weight to about 1.5 parts by weight, from about 0.5 parts by weight to about 1.3 parts by weight, from about 0.5 parts by weight to about 1.1 parts by weight, or from about 0.5 parts by weight to about 1 part by weight based on 100 parts by weight of the toner particles.

When only the small-diameter silica particles are used, charging stability increases but the possibility that the silica particles are buried in the toner particles increases. When only the large-diameter silica particles are used, charging stability may deteriorate due to many voids on the surfaces of toner particles and the possibility that the silica particles are separated from the surfaces of the toner particles increases. To improve these properties, both the small-diameter silica particles and the large-diameter silica particles having different particle diameters may be used together. That is, the small-diameter silica particles may fill small voids between the large-diameter silica particles, thereby improving charging stability and preventing the silica particles from being buried in the toner particles. Accordingly, fluidity of the toner may be maintained even after long-term use, and thus the image-quality retention property may be enhanced.

The small-diameter silica particles have high dispersibility. Silica particles tend to easily aggregate by surface treatment. Aggregation reduces the surface area of the external additive and thus the toner surface-treated with the aggregated silica particles may have a relatively low amount of the silica particles adhered to the surface of the toner particles. Thus, fluidity and charging stability of the toner may be improved by increasing dispersibility using silica particles having low aggregation. Particle diameter distribution of silica particles may be measured by using a particle size analyzer such as a Horiba particle size analyzer. While conventional silica particles exhibit a unimodal particle size distribution, the silica aggregates may have an average diameter of about 5 μm to about 20 μm with a bimodal particle size distribution which has two peaks at about 1 μm or lower and at about 5 μm or higher in the toner according to an example.

The large-diameter silica particles may reduce adhesiveness of the toner to a developing member and a transferring member, thereby improving developing properties and transferability. The large-diameter silica particles present in a monodispersed form may improve performance of the external additive and enhance durability of the toner by preventing the small-diameter silica particles from being separated from the toner particles and from being buried in the toner particles. By using the large-diameter silica particles having a higher specific gravity (i.e., lower porosity), environmental resistance of the toner to high-temperature and high-humidity and low-temperature and low-humidity environments may be improved.

For example, under high-temperature and high-humidity conditions, moisture may permeate into voids formed in the silica when the silica has a low specific gravity. In this case, as moisture has a relatively high electrical conductivity, a charging performance of the toner may deteriorate. As a result, the image density increases, background contamination is worsened, the silica particles are easily detached, and durability of the toner may deteriorate. Thus, the large-diameter silica particles having a specific gravity of about 2 or more may be selected. As porosity of the silica particles decreases, the specific gravity of the silica particles may increase. Since the specific gravity of the silica particles is limited by achievable low porosity, an upper limit of the specific gravity of the large-diameter silica particles is not particularly limited. The upper limit of the specific gravity of the large-diameter silica particles may be, for example, about 2.5.

The external additive attached to the surface of the toner may further include tin oxide particles in addition to the large-diameter and small-diameter silica particles. The tin oxide particles may be SnO₂ particles. The tin oxide particles may improve developing properties, transferring properties, and charging stability in a high-temperature and high-humidity environment and a low-temperature and low-humidity environment of the toner by reducing a charge-up phenomenon.

The small-diameter fumed silica particles may be hydrophobic surface-treated with a hydrophobic surface-treating agent. Also, the tin oxide particles may be hydrophobic surface-treated with a hydrophobic surface-treating agent. If at least one of the small-diameter fumed silica particles and the tin oxide particles are hydrophobically surface-treated, they may have a degree of hydrophobicity of about 10% to about 90%, for example, about 30% or greater, respectively. The large-diameter silica particles may or may not be treated with the hydrophobic surface-treating agent. When at least one of the small-diameter fumed silica particles and the tin oxide particles are hydrophobic surface-treated, improved physical properties of the toner may be exhibited.

A hydrophobic surface-treating agent used to hydrophobicize the small-diameter fumed silica particles and the tin oxide particles may be, for example, silicone oils, silanes, siloxanes, or silazanes. Examples thereof may be selected from the group consisting of dimethyldiethoxy siloxane (DMDES), hexamethyldimethyl siloxane (HMDS), polydimethyl siloxane (PDMS), diethyldimethyl siloxane (DDS), dimethyltrimethoxy silane (DTMS), and mixtures thereof.

The tin oxide particles may have a volume average particle diameter D50 of about 5 nm to about 200 nm, for example, about 10 nm to about 150 nm, or about 20 nm to about 100 nm. In this regard, the average particle diameter D50 refers to a diameter at which the cumulative volume of the tin oxide particles corresponds to 50% of the total cumulative volume of the tin oxide particles in a cumulative volume curve of the tin oxide particles. When a volume average particle diameter D50 of the tin oxide particles is less than about 5 nm, or more than about 200 nm, the effects of tin oxide particles may not be sufficient or the size of the particles may be too large to be suitable for use in a toner.

The amount of the tin oxide particles added may be related to the conditions above. An amount of the tin oxide particles may be from about 0.1 parts by weight to about 3 parts by weight, for example, from about 0.3 parts by weight to about 2.5 parts by weight, from about 0.3 parts by weight to about 2 parts by weight, from about 0.3 parts by weight to about 1.5 parts by weight, or from about 0.3 parts by weight to less than about 1.5 parts by weight based on 100 parts by weight of the toner particles.

When the added amount of the tin oxide particles is less than about 0.1 parts by weight or greater than about 3 parts by weight, the above conditions may not be satisfied. That is, when the added amount of the tin oxide particles is other than from about 0.1 parts by weight to about 3 parts by weight based on 100 parts by weight of the toner particles, characteristics of the toner, for example, environmental charging stability, developing properties, transferring properties, photoreceptor background contamination inhibiting properties, and developing durability may not show the desired effects.

The external additive particles may be attached to the surfaces of the core particles of the toner by using, for example, a powder mixing apparatus without being limited thereto. Examples of the powder mixing apparatus may be, but are not limited to a Henshell mixer, a V-shape mixer, a ball mill, or a Nauta mixer.

A cartridge according to an example may contain the above-mentioned toner for developing an electrostatic image according to an example, and may couple to an apparatus for forming an image.

A toner supply device according to an example may include the toner for developing an electrostatic image according to an example. For example, the toner supply device may include a toner tank to store a toner, a supplying part protruding toward an inner side of the toner tank to supply the stored toner to an outside of the tank, and a toner stirring member rotatably installed inside the toner tank to stir the toner in at least a portion of an inner space of the toner tank including an upper portion of the supplying part. The toner may include a toner for developing an electrostatic image according to an example.

An image forming apparatus according to an example may include the toner for developing an electrostatic image according to an example. For example, the image forming apparatus may include an image carrier, an image forming device to form an electrostatic image on a surface of the image carrier, a toner storage device, a toner supply device to supply the toner to the surface of the image carrier to thereby develop the electrostatic image as a visible image on the surface of the image carrier, and a transferring device to transfer the visible image from the surface of the image carrier to an image receiving member. The toner is one for developing an electrostatic image according to an example.

A method of forming an image according to an example may include forming a visible image by attaching a toner to a surface of an image carrier, e.g., an electrophotographic photoreceptor, on which an electrostatic image is formed, and transferring the visible image to an image receiving member, i.e., a transfer medium or paper. The toner is one for developing an electrostatic image according to an example.

An example method of forming an image includes electrophotography. An electrophotographic process generally includes a charging process to uniformly charge a surface of an electrostatic image carrier, an exposure process to form an electrostatic image by using various photoconductive materials on the charged electrostatic image carrier, a developing process to develop a visible image (e.g., a toner image) by attaching a developing agent such as a toner to the latent image, a transferring process to transfer the visible image onto a transfer medium such as paper, a cleaning process to remove toner that is not transferred and remains on the electrostatic image carrier, a charge eliminating process to remove charges remaining on the electrostatic image carrier, and a fixing or fusing process to fix the visible image by heat or pressure. In this regard, a toner according to an example may be efficiently used for electrophotography.

Hereinafter, examples and a comparative example are provided. However, the present disclosure is not limited thereto.

### Preparation of Sol-Gel Silica

In an example of preparing a sol-gel silica, 60.3 g of ethanol, 5.5 g of distilled water, and 2.2 g of a 28% ammonia solution may be mixed and stirred for 10 minutes using a stirrer. An obtained solution may be maintained at a temperature of 45° C. Further, 143.1 g of tetraethoxysilane (TEOS, molecular weight: 208.33 g) may be added dropwise thereto, and 20.7 g of a 28% ammonia solution and 50.3 g of distilled water may be added dropwise thereto for 6 hours and 4 hours, respectively. After completion of the dropwise addition, the mixture may be stirred for 3 minutes to obtain the sol-gel silica. Ethanol may be distilled off by heating the mixture to obtain hydrophilic sol-gel silica. The obtained sol-gel silica has an average particle size (diameter) of about 70 nm. Then, 5 g of decyl trimethoxysilane (DTMS) may be added to 10 g of the obtained silica to obtain hydrophobic sol-gel silica.

### Preparation of Tin Oxide Particles

The tin oxide particles may be prepared by using a hydrolysis method in such a manner that, after dissolving a tin compound, a proper size of particles may be obtained through proper Ph control. Synthesized tin oxide particles may be obtained by washing, drying, calcining, coating, and drying.

### EXAMPLES

Hereinafter, % refers to % by weight unless otherwise noted.

### Preparation Example 1

### 1. Preparation of L-Type Latex

A mixture of polymerizable monomers (825 g of styrene and 175 g of n-butyl acrylate), 30 g of β-carboxyethyl acrylate (Sipomer, Rhodia), 17 g of 1-dodecanethiol as a chain transfer agent (CTA), and 418 g of an aqueous solution of sodium dodecyl sulfate (Aldrich, 2% in water) as an emulsifier may be added to a 3 L beaker and the mixture may be stirred to prepare a polymerizable monomer emulsion. Further, 16 g of ammonium persulfate (APS) as an initiator and 696 g of an aqueous solution of sodium dodecyl sulfate (Aldrich, 0.4% in water) as an emulsifier may be added to a 3 L double jacket reactor heated to about 75° C. The prepared polymerizable monomer emulsion may be slowly added dropwise to the double jacket reactor for 2 hours or more while stirring. The mixture may be maintained at about 75° C. for about 8 hours. A particle size of the prepared latex measured by a light scattering method (Mictotrac) may be from about 180 nm to about 250 nm. A solid content of the latex measured by a dry weight loss method may be about 42%. A weight average molecular weight (Mw) of the latex measured by gel permeation chromatography (GPC) using the portion of the latex that is soluble in tetrahydrofuran (THF) may be about 25,000 g/mol. A glass transition temperature of the latex measured at a second scanning at a heating rate of 10° C./min by a DSC method (PerkinElmer) may be about 62° C.

### 2. Preparation of H-type Latex

A mixture of polymerizable monomers (685 g of styrene and 315 g of n-butyl acrylate), 30 g of β-carboxyethyl acrylate (Sipomer, Rhodia), and 418 g of an aqueous solution of sodium dodecyl sulfate (Aldrich, 2% in water) as an emulsifier may be added to a 3 L beaker and the mixture may be stirred to prepare a polymerizable monomer emulsion. Further, 5 g of ammonium persulfate (APS) as an initiator and 696 g of an aqueous solution of sodium dodecyl sulfate (Aldrich, 0.4% in water) as an emulsifier may be added to a 3 L double jacket reactor heated to about 60° C. The prepared polymerizable monomer emulsion may be slowly added dropwise to the double jacket reactor for 3 hours or more while stirring. The mixture may be maintained at about 75° C. for about 8 hours. A particles size of the prepared latex measured by a light scattering method (Horiba 910) may be from about 180 nm to about 250 nm. A solid content of the latex measured by a dry weight loss method may be about 42%. A weight average molecular weight (Mw) of the latex measured by gel permeation chromatography (GPC) using the portion of the latex that is soluble in THF may be about 25,000 g/mol. A glass transition temperature (Tg) of the latex measured at a second scanning at a heating rate of 10° C./min by the DSC method (PerkinElmer) may be about 53° C.

### 3. Preparation of Pigment Dispersion

In an example, 10 g of sodium dodecyl sulfate as an anionic reactive emulsifier and 60 g of a carbon black pigment may be added to a milling bath, and 400 g of glass beads having a diameter of about 0.8 mm to about 1 mm may be added thereto. The mixture may be milled at room temperature to prepare a dispersion. An ultrasonic homogenizer or a microfluidizer may be used to disperse the mixture. A particle diameter of the pigment dispersion measured by a light scattering method (Horiba 910) may be from about 180 nm to about 200 nm. A solid content of the prepared pigment dispersion may be about 18.5%.

### 4. Preparation of Agglomerated Toner

In an example, 3000 g of deionized water, 700 g of a latex mixture for core particles (e.g., a mixture of 95% of the L-type latex and 5% of the H-type latex), 195 g of the pigment dispersion, and 237 g of a wax dispersion (P787, Chukyo Yushi, Co., Ltd., Solid content: about 30.5%) may be added to a 7 L reactor. A mixture of 364 g of nitric acid (0.3 mol), and 182 g of polysilicate indium (Aldrich) may be added to the reactor, the mixture may be stirred by using a homogenizer at about 11,000 rpm for 6 minutes, and 417 g of the latex mixture may be further added and the mixture further stirred for 6 minutes to obtain agglomerates having a size of about 1.5 μm to about 2.5 μm.

The mixture may be added to a 7 L double jacket reactor and heated from room temperature to a temperature of about 55° C. (Tg of the latex-5° C.) at a rate of 0.5° C./min. When the particle diameter D50 (Volume) reaches about 6.0 μm, 442 g of the latex mixture (a mixture of 90% of the L-type latex and 10% of the H-type latex) may be slowly added thereto for about 20 minutes. When the particle diameter D50 (Volume) reaches about 6.8 μm, the pH of the mixture may be adjusted to about 7 by adding 1 mol NaOH. The particle diameter D50 (Volume) may be maintained for 10 minutes and the reactor heated to about 96° C. After the temperature reaches about 96° C., the pH may be adjusted to about 6.0, and coalescence may be performed for 3 to 5 hours to obtain a secondary agglomerated toner with a potato shape having a particle diameter D50 (Volume) of about 6.5 μm to about 7.0 μm. Then, the agglomerated reaction solution may be cooled below the glass transition temperature (Tg) and the toner particles may be separated by filtration and dried.

### Example 1: Preparation of Externally Added Toner

In an example, to externally add inorganic fine particles to surfaces of untreated dry toner particles, 100 parts by weight of the untreated toner particles may be added to a mixer (manufactured by DAEWHA TECH IND., model name: KMLS2K), and then 2.0 parts by weight of sol-gel silica having a primary particle diameter of about 70 nm and an apparent density of about 220 g/L and satisfying the specifications shown in Table 1 below (SG50, Suckyoung), 1.0 part by weight of small-diameter fumed silica having a primary particle diameter of about 16 nm and hydrophobicized with diethyldimethyl siloxane (DDS) (AEROSIL®R972, Evonik Industries), and tin oxide (SG-SNO10, Suckyoung) may be further added to the mixer. The mixture may be mixed in a 2 L stirrer at about 2000 rpm for 30 seconds and then further stirred at about 6000 rpm for 3 minutes to obtain externally added toner particles.

The toner particles thus obtained may have a volume average particle diameter D50 (Volume) of about 6.5 μm to about 7.0 μm. The toner may have a GSDp value of 1.282 and a GSDv value of 1.217. The toner particles may have an average circularity of 0.971.

### Examples 2 to 7 and Comparative Examples 1 and 2: Preparation of Externally Added Toner

Toners according to Examples 2 to 7 and Comparative Examples 1 and 2 were prepared in the same manner as in Example 1, except that the types and/or amounts of the external additives, i.e., large-diameter spherical sol-gel silica particles, small-diameter silica particles, and tin oxide particles, were varied as shown in Table 2 below.

TABLE 1

| | | | | Content |
|---|---|---|---|---|
| | | | | (reference: 100 |
| | | | | parts by weight |
| | Particle | Surface | | of untreated |
| | size | area | Source | particles of |
| | (nm) | (m²/g) | (Product name) | toner) |
| Large-diameter | 70 | 50 | Sukgyung, Korea, | 2.0 |
| sol-gel silica | | | (SG50) | |
| particles | | | | |
| Small-diameter | 16 | 130 | Evonik Industries, | 1.0 |
| silica particles | | | Germany | |
| | | | (AEROSIL ®R972) | |
| Tin oxide | 45 | 60 | Sukgyung, Korea, | 0.6 |
| particles | | | (SG-SNO10) | |

TABLE 2

| | Large-diameter sol-gel | | | | | | | | | | |
|---|---|---|---|---|---|---|---|---|---|---|---|
| | silica particles | | | Small-diameter silica particles | | | | Tin oxide or titanium oxide | | | |
| | PD^{##} | SA^{###} | Amt. | PD | SA | | Amt. | | SA | | Amt. |
| | (nm) | (m²/g) | (pbw^{####}) | (nm) | (m²/g) | HSTA^{#####} | (pbw) | material/PD(nm) | (m²/g) | HSTA | (pbw) |
| Ex. 1 | 70 | 50 | 2.0 | 16 | 130 | DDS* | 1.0 | Tin oxide/28 nm | 60 | DMDES** 20% | 0.3 |
| Ex. 2 | 70 | 50 | 2.0 | 16 | 130 | DDS | 1.0 | Tin oxide/28 nm | 60 | DMDES 20% | 0.6 |
| Ex. 3 | 70 | 50 | 2.0 | 16 | 130 | DDS | 1.0 | Tin oxide/28 nm | 60 | DMDES 20% | 0.9 |
| Ex. 4 | 70 | 50 | 2.0 | 16 | 130 | DDS | 1.0 | Tin oxide/28 nm | 60 | DMDES 20% | 1.2 |
| Ex. 5 | 70 | 50 | 2.0 | 16 | 130 | DDS | 1.0 | Tin oxide/28 nm | 60 | PDMS*** 20% | 1.0 |
| Ex. 6 | 70 | 50 | 2.0 | 16 | 130 | DDS | 1.0 | Tin oxide/28 nm | 60 | HMDS**** 20% | 1.0 |
| Ex. 7 | 70 | 50 | 2.0 | 16 | 130 | DDS | 1.0 | Tin oxide/28 nm | 60 | DMDES 20% | 1.5 |
| CE^{#}1 | 70 | 50 | 2.0 | 16 | 130 | DDS | 1.0 | Tin oxide/28 nm | 60 | DMDES 20% | 0.0 |
| CE 2 | 70 | 50 | 2.0 | 16 | 130 | DDS | 1.0 | Titanium oxide/28 nm | 60 | DMDES 20% | 0.6 |

*DDS: diethyldimethyl siloxane
**DMDES: dimethyldiethoxy siloxane
***PDMS: polydimethyl siloxane
****HMDS: hexamethyldimethyl siloxane
^{#}CE: Comparative Example
^{##}PD: particle diameter
^{###}SA: surface area
^{####}pbw: parts by weight
^{#####}HSTA: hydrophobic surface treating agent

Physical properties of the toners prepared according to Examples 1 to 7 and Comparative Examples 1 and 2 are shown in Table 3 and Table 4 below.

TABLE 3

| | Environmental | | | Photoreceptor | |
|---|---|---|---|---|---|
| | Charging | Developing | | Background | Developing |
| Example | Stability | Property | Transferability | Contamination | Durability |
| Ex. 1 | ⊚ | ◯ | ⊚ | ⊚ | ⊚ |
| Ex. 2 | ⊚ | ⊚ | ⊚ | ⊚ | ⊚ |
| Ex. 3 | ⊚ | ⊚ | ⊚ | ◯ | ⊚ |
| Ex. 4 | ◯ | ⊚ | ⊚ | ◯ | ◯ |
| Ex. 5 | ⊚ | ◯ | Δ | ◯ | ⊚ |
| Ex. 6 | ◯ | ⊚ | ⊚ | Δ | ◯ |
| Ex. 7 | ◯ | Δ | Δ | ⊚ | ◯ |
| CE 1 | X | ◯ | ◯ | Δ | Δ |
| CE 2 | Δ | ◯ | ◯ | X | ⊚ |

TABLE 4

| | | | XRF | |
|---|---|---|---|---|
| | | | [Sn]intensity, | |
| | | | [Si] intensity, | XRD |
| XRF/ | Sn | Si | [Sn]/[Si] | Sn intensity (cps) |
| XRD | intensity | intensity | Sn/Si | 2θ = 26.6/33.8/51.8 |
| Ex. 1 | 14.9 | 0.0897 | 165.57 | 86 ± 2/26 ± 2/5 ± 2 |
| Ex.2 | 31.06 | 0.0941 | 330.14 | 124 ± 2/86 ± 2/46 ± 2 |
| Ex. 4 | 46.3 | 0.0858 | 539.69 | 192 ± 2/128 ± 2/87 ± 2 |

Properties of the toners prepared according to Examples 1 to 7 and Comparative Examples 1 and 2 shown in Tables 3 and 4 were evaluated by the following tests.

### <Evaluation Methods>

### Measurement of [Sn] Intensity, [Si] Intensity, and [Sn]/[Si] Intensity Ratio

Intensity of Sn [Sn] and intensity of Si [Si] of the toners were measured by XRF spectrometry according to the following procedure.

The XRF measurement method was performed by using EDX-720 equipment for 50s in a Ti—U mode, and 50s in a Na—Sc mode.

### Diffraction Intensity (2θ) of X-Ray Diffractometer (XRD: X-Ray Diffractometer, Titanium Oxide, Tin Oxide)

The titanium oxide/tin oxide contained in the toners were analyzed by using a Rigaku ULTIMA IV XRD at Cu Ka (λ=1.5148 Å) 40 Kv, 40 mA.

Toner containing tin oxide exhibited a distinctive peak at diffraction intensity 2θ=26.6°/33.8°/51.8°.

Subsequently, the following experiments were conducted to evaluate properties of the toners of Examples 1 to 7 and Comparative Examples 1 and 2.

Images were printed on up to 5000 sheets of paper at a coverage rate of 1% using a one-component developing type of printer (CLP 680, Samsung Electronics) to evaluate developing properties, transferring properties, image density, image contamination, and changes in properties over time (e.g., changes in the toner layer on a developing roller and changes in image density according to the number of prints) according to printing conditions.

### Environmental Charging Stability

Evaluation was performed by using an EPPING q/m meter as a measuring device under the conditions of a voltage of 105 V and an air flow rate of 2.0 L/min according to the following procedure.

0.5 g of a toner and 9.5 g of a carrier were added to a 200 cc bottle and mixed using a TURBULAR mixer for about 3 minutes to prepare a toner sample. The toner sample was maintained under a low-temperature and low-humidity (LL) condition (10° C., relative humidity of 10%) and a high-temperature and high-humidity (HH) condition (30° C., relative humidity of 80%), respectively. Then, charging performance thereof was evaluated to measure a charge amount in each environment and charging stability was evaluated according to the following criteria.

⊚: Charge amount ratio of HH/LL of 0.9 to 1.0 (Excellent state in which almost no difference between charge amounts in different environmental conditions was found)

∘: Charge amount ratio HH/LL of 0.8 to less than 0.9 (Good state in which a small difference between charge amounts in different environmental conditions was found)

●: Charge amount ratio of HH/LL of 0.7 to less than 0.8 (State in which a large difference between charge amounts in different environmental conditions was found)

X: Charge amount ratio of HH/LL of less than 0.7 (State in which a very large difference between charge amounts in different environmental conditions was found)

### Developing Property

After printing 1000 sheets of paper, an image with a certain area was developed on an electrophotographic photoreceptor before the toner was transferred to an intermediate transfer member from the electrophotographic photoreceptor, and the weight of the toner per unit area of the electrophotographic photoreceptor was measured using a suction device equipped with a filter. In this regard, the weight of the toner per unit area on a developing roller was simultaneously measured and the developing property was evaluated using the following method.

Developing efficiency=Weight of toner per unit area of electrophotographic photoreceptor/weight of toner per unit area of developing roller×100(%)

⊚: Developing efficiency of 90% or greater

∘: Developing efficiency of 80% to less than 90%

Δ: Developing efficiency of 70% to less than 80%

X: Developing efficiency of 60% to less than 70%

### Transferability (Primary and Secondary)

Primary transferability was evaluated using a ratio of the weight of the toner per unit area of the intermediate transfer member after transferring the toner to the intermediate transfer member from the electrophotographic photoreceptor to the weight of the toner per unit area of the electrophotographic photoreceptor, obtained through evaluation of a developing property described above. In addition, secondary transferability was evaluated using a ratio of the weight of the toner per unit area on printing paper after the toner was transferred to the printing paper to the weight of the toner per unit area of the intermediate transfer member. In this regard, to evaluate transferability, the weight of the toner per unit area on printing paper was measured using an unfixed image.

Primary transferability=Weight of toner per unit area of intermediate transfer member/weight of toner per unit area of electrophotographic photoreceptor×100(%)

Secondary transferability=Weight of toner per unit area of paper/weight of toner per unit area of intermediate transfer member×100(%)

Transferability=Primary transferability X Secondary transferability.

Transferability of the toners was evaluated according to the following criteria.

⊚: Transferability of 90% or greater

∘: Transferability of 80% to less than 90%

Δ: Transferability of 70% to less than 80%

X: Transferability of 60% to less than 70%

### Photoreceptor Background Contamination

After printing images on 1000 sheets of paper, a non-image area on a photoreceptor drum (i.e., electrophotographic photoreceptor) was taped. Optical densities at the three locations were measured and an average thereof was calculated. The optical density was measured using an “Electroeye” Reflection Densitometer. Performance of preventing photoreceptor background contamination was evaluated according to the following criteria.

⊚: Optical density of less than 0.03 (indicating excellent performance of preventing photoreceptor background contamination)

∘: Optical density of 0.03 to less than 0.05 (indicating performance of preventing photoreceptor background contamination)

Δ: Optical density of 0.05 to less than 0.07 (indicating poor performance of preventing photoreceptor background contamination)

X: Optical density of 0.07 or greater (indicating very poor performance of preventing photoreceptor background contamination)

### Developing Durability (Time-dependent Change)

Images were printed on up to 5000 sheets of paper and image densities over time were measured at every print of 1000 sheets to evaluate degrees of changes in comparison with an initial state as the number of prints increased. Measurement results were classified according to the following criteria.

⊚: Less than 10% change in image density after printing 5000 sheets when compared to the initial state (indicating excellent developing durability of toner)

∘: 10% to less than 20% change in image density after printing 5000 sheets when compared to the initial state (indicating good developing durability of toner)

Δ: 20% to less than 30% change in image density after printing 5000 sheets when compared to the initial state (indicating poor developing durability of toner)

X: 40% or more change in image density after printing 5000 sheets when compared to the initial state (indicating very poor developing durability of toner)

Referring to Table 3, it is illustrated that the toners prepared according to Examples 1 to 7 having the [La] XRF intensity, the [Sr] XRF intensity, the [La]/[Si] XRF intensity ratio, and the [Sr]/[Si] XRF intensity ratio satisfying all of conditions (1), (2), (3), and (4) have excellent environmental charging stability, developing properties, transferability, and developing durability, and low photoreceptor background contamination.

According to various examples, a toner for developing an electrostatic image having excellent fusibility, fluidity, transferability, charging stability, and developing properties and effectively inhibiting photoreceptor background contamination may be obtained.

It should be understood that the examples described herein should be considered in a descriptive sense only and not for purposes of limitation. Descriptions of features within each example should typically be considered as available for other similar features in other examples.

While one or more examples have been described, it will be understood by those of ordinary skill in the art that various changes in form and details may be made therein without departing from the spirit and scope as defined by the following claims.

What is claimed is:

1. A toner having a plurality of toner particles, the toner comprising:
a core particle including a binder resin, a colorant, and a releasing agent; and
an external additive to attach to a surface of the core particle, the external additive including silica particles and tin oxide particles,
wherein an X-ray diffraction intensity 28 determined in units of counts per second (cps) of the toner measured by an X-ray diffractometer (XRD) satisfies the following conditions:
0.4<[intensity of 2θ=26.6±0.2°,2θ=33.8±0.2°,2θ=51.8±0.2°]<500;
0≤[intensity of 2θ=25.3±0.2°,2θ=48.0±0.2°]<10; and
0≤[intensity of 2θ=27.4±0.2°,2θ=36.1,2θ=54.3±0.2°]<10.

2. The toner of claim 1, wherein an X-ray fluorescence (XRF) intensity of tin oxide [Sn] of the toner as determined in units of kilocounts per second (kcps) and an XRF intensity of silicon [Si] as determined in units of kcps of the toner measured by XRF spectrometry satisfy the following condition:
0.00<[Sn]/[Si]1000.

3. The toner of claim 1, wherein an amount of the tin oxide particles is from 0.1 parts by weight to 3 parts by weight based on 100 parts by weight of the toner particles.

4. The toner of claim 1, wherein the tin oxide particles comprise tin oxide particles that are hydrophobic surface-treated with a hydrophobic surface-treating agent.

5. The toner of claim 4, wherein the hydrophobic surface-treating agent is selected from the group consisting of dimethyldiethoxy siloxane (DMDES), hexamethyldimethyl siloxane (HMDS), polydimethyl siloxane (PDMS), diethyldimethyl siloxane (DDS), dimethyltrimethoxy silane (DTMS), and mixtures thereof.

6. The toner of claim 1, wherein the silica particles comprise silica particles that are hydrophobic surface-treated.

7. The toner of claim 1, wherein the silica particles include:
large-diameter silica particles having a volume average particle diameter D50 of about 50 nm to about 300 nm; and
small-diameter silica particles having a volume average particle diameter D50 of about 5 nm to less than 50 nm,
wherein the volume average particle diameter D50 is a diameter at which a cumulative volume of the silica particles corresponds to 50% of a total cumulative volume of the silica particles in a cumulative volume curve of the silica particles.

8. The toner of claim 7, wherein the small-diameter silica particles comprise small-diameter silica particles that are hydrophobic surface-treated.

9. The toner of claim 7, wherein the large-diameter silica particles comprise large-diameter spherical sol-gel silica particles.

10. The toner of claim 1,
wherein the tin oxide particles have a volume average particle diameter D50 of 20 nm to 100 nm, and
wherein the volume average particle diameter D50 is a diameter at which a cumulative volume of the tin oxide particles corresponds to 50% of a total cumulative volume of the tin oxide particles in a cumulative volume curve of the tin oxide particles.

11. A cartridge couplable to an apparatus for forming an image, the cartridge comprising:
a toner for developing an electrostatic image,
wherein the toner includes a plurality of toner particles, the toner comprising:
a core particle including a binder resin, a colorant, and a releasing agent; and
an external additive to attach to a surface of the core particle, the external additive including silica particles and tin oxide particles,
wherein an X-ray diffraction intensity 28 determined in units of counts per second (cps) of the toner measured by an X-ray diffractometer (XRD) satisfies the following conditions:
0.4<[intensity of 2θ=26.6±0.2°,2θ=33.8±0.2°,2θ=51.8±0.2°]<500;
0≤[intensity of 2θ=25.3±0.2°,2θ=48.0±0.2°]<10; and
0≤[intensity of 2θ=27.4±0.2°,2θ=36.1,2θ=54.3±0.2°]<10.

12. An image forming apparatus comprising:
an image carrier;
an image forming device to form an electrostatic image on a surface of the image carrier;
a toner storage device to store toner;
a toner supply device to supply the toner to a surface of the image carrier to develop the electrostatic image as a visible image on the surface of the image carrier; and
a transferring device to transfer the visible image from the surface of the image carrier to an image receiving member,
wherein the toner includes a plurality of toner particles, the toner comprising:
a core particle including a binder resin, a colorant, and a releasing agent; and
an external additive to attach to a surface of the core particle, the external additive including silica particles and tin oxide particles,
wherein an X-ray diffraction intensity 28 determined in units of counts per second (cps) of the toner measured by an X-ray diffractometer (XRD) satisfies the following conditions:
0.4<[intensity of 2θ=26.6±0.2°,2θ=33.8±0.2°,2θ=51.8±0.2°]<500;
0≤[intensity of 2θ=25.3±0.2°,2θ=48.0±0.2°]<10; and
0≤[intensity of 2θ=27.4±0.2°,2θ=36.1,2θ=54.3±0.2°]<10.

13. The image forming apparatus of claim 12, wherein an X-ray fluorescence (XRF) intensity of tin oxide [Sn] of the toner as determined in units of kilocounts per second (kcps) and an XRF intensity of silicon [Si] as determined in units of kcps of the toner measured by XRF spectrometry satisfy the following condition:
0.0<[Sn]/[Si]1000.

14. The image forming apparatus of claim 12, wherein an amount of the tin oxide particles is from 0.1 parts by weight to 3 parts by weight based on 100 parts by weight of the toner particles.

15. The image forming apparatus of claim 12, wherein the silica particles include:
large-diameter silica particles having a volume average particle diameter D50 of about 50 nm to about 300 nm; and
small-diameter silica particles having a volume average particle diameter D50 of about 5 nm to less than 50 nm,
wherein the volume average particle diameter D50 is a diameter at which a cumulative volume of the silica particles corresponds to 50% of a total cumulative volume of the silica particles in a cumulative volume curve of the silica particles.
